(19) United States
(12) Patent Application Publication
(10) Pub. No.: US 2026/0245546 A1
(43) Pub. Date: Aug. 20, 2026

(54) SENSOR DATA ANALYSIS

(71) Applicant: Unseen AI Incorporated, Brooklyn, NY (US)

(72) Inventors: Amanda Blair Lind, Brooklyn, NY (US); Wenyu Jin, Medina, MN (US)

(21) Appl. No.: 19/539,804

(22) Filed: Feb. 13, 2026

Related U.S. Application Data
(60) Provisional application No. 63/758,863, filed on Feb. 14, 2025.

(51) Int. Cl. G10L 15/06

(52) U.S. Cl. CPC G10L 15/063

(57) ABSTRACT

Systems and methods for improved contextual analysis, spatial localization, and classification of multi-channel sensor data are disclosed. A sensor data analysis system receives multi-channel time-series sensor data and sensor geometry data, computes wavelet-based time-frequency feature representations preserving both magnitude and phase information, and encodes the feature representations into audio embeddings using a selective state space model with linear computational complexity. A dynamic-static interaction module fuses the time-variant audio embeddings with time-invariant sensor geometry data using a cross-attention mechanism to produce geometry-conditioned embeddings that enable hardware-geometry-agnostic deployment. A multi-headed output architecture processes the geometry-conditioned embeddings through an anomaly detection head, a time-sensitive classification head, and an audio language model head operating in conjunction with a large language model adapted through low-rank adapters, enabling simultaneous anomaly detection, event classification with spatial localization, and natural language scene description from a single shared encoder backbone deployable on edge devices.

### CROSS-REFERENCE TO RELATED APPLICATIONS

This application claims the benefit of U.S. Provisional Patent Application No. 63/758,863, filed Feb. 14, 2025, titled “IMPROVED SYSTEM AND TECHNIQUES FOR SENSOR DATA ANALYZATION,” which is hereby incorporated by reference in its entirety and for all purposes.

### STATEMENT REGARDING FEDERALLY SPONSORED RESEARCH OR DEVELOPMENT

Not applicable.

### TECHNICAL FIELD

The present disclosure relates generally to systems and methods for processing, analyzing, and classifying sensor data. More specifically, the present disclosure relates to improved techniques for contextual analysis, spatial localization, and classification of multi-channel and multi-modal sensor data.

### BACKGROUND

Audio data and other time-series sensor data (including data acquired from airborne sound via microphones, accelerometers, optical vibration measurement devices, ultrasonic transducers, or other sensing modalities) may be processed to determine one or more labels associated with the source of the data, and in some cases, to determine the spatial location of such sources. Such processing is important in a wide range of applications, including autonomous vehicles, robotics, critical infrastructure monitoring, manufacturing, construction, and smart city applications. However, current techniques for processing multi-channel and multi-modal sensor data suffer from several specific and well-documented technical deficiencies.

A first technical deficiency of conventional approaches relates to scalability limitations arising from fixed-architecture signal processing pipelines. In a typical conventional system for acoustic scene understanding, a digital signal processing (DSP) pipeline is concatenated with a machine-learning-based classifier in a sequential, modular arrangement. For example, a conventional autonomous vehicle acoustic sensing system may include: (a) a signal processing block that computes spatial information about only the single loudest source, sometimes with a frequency weighting applied to improve the probability of localizing a class of interest; (b) a machine-learned classifier, often a convolutional neural network (CNN), trained to recognize a short, fixed list of finite sound classes, producing a detection confidence metric; (c) a signal processing beamformer to improve signal-to-noise ratio (SNR) for speech; and (d) a separate speech-to-text engine. Each of these components is engineered independently, and adding a new detection class to such a system typically requires a full quarter of work by a specialized engineering team. This architecture does not scale effectively because each new sensing capability requires custom engineering of additional DSP blocks, additional classifiers, and integration testing. The computational complexity of the overall system grows linearly or super-linearly with the number of sensing tasks, because each task requires its own dedicated processing pathway.

A second technical deficiency relates to information loss. In conventional approaches, the DSP blocks that precede the machine-learned classifier necessarily reduce the dimensionality of the sensor data before the classifier receives it. For example, a conventional beamformer may produce a single steered audio channel from a multi-channel input, discarding spatial information that is not aligned with the steering direction. As another example, a conventional feature extractor may compute mel-frequency cepstral coefficients (MFCCs) from a spectrogram, discarding phase information entirely. This phase information, however, carries critical spatial cues including inter-channel time differences and inter-channel phase differences. Once discarded by the DSP front-end, this information is irrecoverably lost and unavailable to the downstream classifier. Furthermore, because each module in the conventional pipeline operates on a reduced representation from the preceding module, the overall pipeline suffers from cascading information loss.

A third technical deficiency relates to outlier handling and rare event detection. Conventional classifiers trained on a fixed class taxonomy are inherently unable to detect or classify acoustic events that fall outside the training taxonomy. For example, a conventional siren detection system trained to recognize specific siren waveforms (e.g., wail, yelp, hi-lo) may fail to detect an atypical emergency vehicle siren or a foreign siren pattern. Such a system produces no output for events outside its training distribution, and may produce false negative results when a genuine emergency vehicle employs an unrecognized siren modulation. This is a critical safety deficiency in autonomous vehicle applications, where failure to detect an emergency vehicle may violate applicable traffic laws (e.g., California Vehicle Code Section 21806, which requires vehicles to yield right-of-way upon approach of an emergency vehicle sounding a siren within 1,000 feet).

A fourth technical deficiency relates to the inability of conventional approaches to exploit correlations between spatial information and acoustic event classification. In a conventional pipeline, spatial processing (beamforming, direction-of-arrival estimation) and event classification are performed in separate, sequential stages. The spatial processing stage does not benefit from knowledge of what type of sound is being localized, and the classification stage does not benefit from spatial context. For example, a conventional system cannot simultaneously determine that a siren-like sound is located at 45 degrees azimuth and 200 meters distance, and that because of its spatial trajectory (approaching at a rate consistent with an emergency vehicle), it is more likely to be a genuine emergency vehicle than a car alarm at a fixed position. This decoupled architecture prevents the system from jointly reasoning about spatial and semantic information.

A fifth technical deficiency relates to hardware specificity. Conventional DSP-based pipelines are designed for a specific sensor array geometry (e.g., a specific number of microphones at specific spatial positions with a specific inter-element spacing). When the array geometry changes—for example, when adapting the system from one vehicle platform to another, or from a vehicle to a drone, or from a drone to a building-mounted installation—the DSP pipeline must be substantially re-engineered. Beamformer coefficients, spatial filters, and array manifold vectors must all be recomputed or redesigned. This hardware specificity imposes significant engineering cost and time for each new deployment configuration.

A sixth technical deficiency relates to the computational burden of deploying multiple independent sensing capabilities. Because a conventional system requires separate processing pathways for anomaly detection, event classification, speech recognition, and spatial localization, the aggregate computational requirements are the sum of the individual pathways. For edge deployment on computationally constrained platforms (e.g., autonomous vehicles, drones, robots, IoT devices), this aggregate cost may exceed the available compute budget, forcing system designers to omit sensing capabilities or accept reduced performance. For example, a drone with limited onboard compute may be forced to choose between running a siren detector or a speech recognizer, but not both simultaneously.

A seventh technical deficiency relates to the lack of adequate training data for multi-channel, spatially-aware acoustic models. The shortage of multi-channel acoustic data arises from two principal causes: (a) raw multi-channel acoustic sensor streams in mobile devices are not exposed to application developers, preventing large-scale data collection from consumer devices; and (b) the physics-based simulation tools required to generate synthetic multi-channel data at the scale needed for machine learning training do not exist in a form suitable for outdoor, mobile, and multi-vehicle acoustic scenarios. Existing acoustic simulation tools are predominantly focused on indoor room acoustics for architectural or virtual reality applications and do not model outdoor propagation effects including atmospheric absorption, sound speed gradients, terrain-dependent ground reflection, and vehicle-induced acoustic scattering. The absence of large-scale, physically accurate multi-channel training data is a fundamental bottleneck that prevents conventional approaches from achieving adequate generalization across deployment environments.

An eighth technical deficiency relates to microphone array specificity in existing multi-channel systems. Existing multi-channel audio systems that conduct spatial scene recognition (i.e., sound event localization and detection) using both DSP and ML-based methods are specifically designed or trained based on datasets collected by one microphone array setup. When a new microphone array with different microphone spatial interval, geometrical shape, or number of microphones is introduced, training data collection using the new microphone array is generally required, and the model must be retrained. This array-specificity prevents existing systems from generalizing across deployment platforms and imposes significant engineering and data collection costs for each new hardware configuration.

A ninth technical deficiency relates to the limitations of existing multi-modal audio-language models. Recent advances in large language models (LLMs) have produced several audio-language systems, including systems such as Gemini 2.0 Flash (which processes video and stereo audio to produce general captioning), GAMA (which provides audio understanding with limited spatial awareness), Qwen-Audio (an audio-language model operating on mono audio input only), and Pengi (which provides audio captioning without multi-channel support). While these systems demonstrate progress in audio understanding, they share common limitations: (a) they operate on mono or stereo audio input and do not support arbitrary multi-channel sensor arrays; (b) they do not provide spatial localization of individual sound sources (azimuth, elevation, distance, trajectory); (c) they do not support simultaneous anomaly detection and classification alongside natural language generation; and (d) they are not designed for real-time, safety-critical applications on edge devices with constrained compute budgets. The current state of the industry for multi-modal LLM applications receives mono audio as input and outputs general captioning, sometimes with a prompt consistent with datasets such as AudioSet. These existing solutions lack spatial understanding, multi-source localization, and the ability to reason about acoustic scenes in the context of specific sensor array geometries.

In the domain of multi-channel spatial audio processing, sound event localization and detection (SELD) systems, including those developed for the DCASE challenge (e.g., SELD-net and its variants), process multi-channel audio to jointly localize and classify sound events. However, these systems are trained on and designed for fixed sensor array geometries (e.g., a specific tetrahedral microphone array or an Eigenmike spherical array) and rely on DSP-derived spatial features such as generalized cross-correlation with phase transform (GCC-PHAT) or spatial pseudo-spectrum (SALSA) features. When the sensor array geometry changes, these systems require retraining with data collected from the new array. They do not integrate language models for natural language scene description, do not support anomaly detection, and do not provide a mechanism for geometry-agnostic deployment across arbitrary sensor configurations.

In the domain of state space models for audio, recent work has applied selective state space models (e.g., Mamba) to audio classification tasks. However, these applications operate on mono audio input, do not incorporate sensor array geometry as a model input, do not provide multi-headed output with simultaneous anomaly detection, classification, and language generation, and do not address the geometry-agnostic deployment problem.

In the domain of acoustic simulation, existing tools include CATT-Acoustic and Treble (which provide ray-based and wave-based simulation for architectural and room acoustics), COMSOL Multiphysics (which provides finite element acoustic simulation for engineering analysis), and SoundPLAN (which provides environmental noise mapping and prediction implementing standardized outdoor propagation models such as ISO 9613-2 and CNOSSOS-EU for regulatory compliance). While these tools address their respective domains, none provides an automated pipeline for generating labeled, multi-channel machine learning training data from a systems engineering specification. CATT-Acoustic and Treble are designed for indoor room acoustics and do not model outdoor propagation effects including atmospheric absorption, sound speed gradients, and terrain-dependent ground reflection. COMSOL provides accurate wave-based simulation but is a general-purpose engineering tool that requires manual configuration for each simulation scenario. SoundPLAN computes steady-state noise level predictions for outdoor environmental assessment but does not produce time-domain multi-channel impulse responses, does not model sensor array configurations or platform enclosure scattering, and does not generate the time-varying acoustic scenes with moving sources required for training spatial audio ML models. None of these tools automatically loads sound source configurations from a specification file, curates training datasets, or produces labeled multi-channel training data across a combinatorial space of sensor array geometries, platform enclosure shapes, and deployment environments without manual user configuration for each geometry and platform shape. The present disclosure addresses this gap by providing an end-to-end automated pipeline that receives a systems engineering specification file and produces curated, labeled synthetic training data suitable for training geometry-agnostic sensor data analysis models.

### BRIEF SUMMARY OF THE INVENTION

The present disclosure describes improved systems and techniques for contextual analysis, spatial localization, and classification of sensor data received by one or more sensors. The disclosed sensor data analysis system employs a unified neural architecture featuring an audio perception encoder based on a selective state space model (SSM), such as a bidirectional Mamba architecture, or alternatively an Audio Spectrogram Transformer (AST) or Self-Supervised Audio Spectrogram Transformer (SSAST). The selective SSM encoder achieves linear computational complexity with respect to input sequence length, enabling processing of high-resolution, multi-channel sensor data within the compute budgets of edge devices. A dynamic-static interaction module fuses time-variant audio embeddings with time-invariant sensor geometry data using a cross-attention mechanism, enabling the system to be deployed on sensor arrays of arbitrary geometry without re-engineering or retraining.

The system further provides a multi-headed output architecture that processes geometry-conditioned audio embeddings through three specialized output heads: an anomaly detection head that detects deviations from a learned baseline acoustic profile with spatial localization, a time-sensitive classification head that classifies acoustic events with low latency using a hierarchical class label taxonomy and provides spatial direction and distance estimates, and an audio language model head operating in conjunction with a large language model (LLM) adapted through Low-Rank Adaptation (LoRA) to produce natural language scene descriptions including speech transcription. This multi-headed architecture enables simultaneous anomaly detection, event classification, and natural language scene description from a single shared encoder backbone.

The disclosed techniques additionally employ wavelet-based feature representations that preserve both magnitude and phase information across heterogeneous frequency ranges, enabling cross-frequency transfer learning and processing of data from sensors operating at different frequency scales. A hybrid simulation pipeline combining wave-based simulation (e.g., Finite-Difference Time-Domain (FDTD), Boundary Element Method (BEM), Finite Element Method (FEM), or other numerical methods that solve the acoustic wave equation) and ray-based simulation (e.g., Geometrical Acoustics (GA), Image Source Method (ISM), or beam tracing) generates physically accurate synthetic multi-channel training data at scale for arbitrary sensor array geometries and deployment environments. The system also integrates actuation signals (e.g., motor RPM, drive current) as conditioning inputs to the encoder, enabling the system to distinguish self-generated platform noise from external acoustic events. The combination of these techniques enables deployment on computationally constrained edge devices with a compute budget comparable to that of a conventional single-channel speech-to-text engine.

### BRIEF DESCRIPTION OF THE DRAWINGS

Features of the present disclosure, its nature, and various advantages will be more apparent upon consideration of the following detailed description, taken in conjunction with the accompanying drawings. The drawings are not to scale.

FIG. 1 is a block diagram of a conventional sensor data processing pipeline illustrating the sequential, modular architecture with single-purpose classifiers, according to an embodiment of the present disclosure.

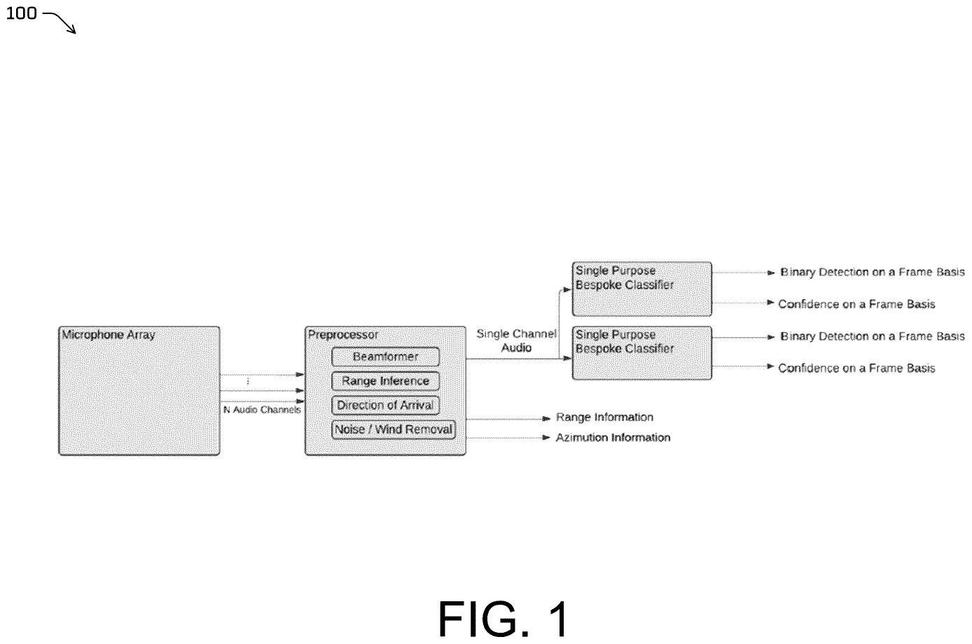

FIG. 2 is a high-level block diagram of a sensor data analysis system according to an embodiment of the present disclosure, illustrating the unified multi-channel architecture with audio perception encoder, dynamic-static interaction module, and multi-headed output.

FIG. 3 is a block diagram of the sensor data analysis system according to an embodiment of the present disclosure, illustrating the audio perception encoder, the dynamic-static interaction module with cross-attention fusion of time-variant audio embeddings and time-invariant sensor geometry features, the multi-headed output architecture including anomaly detection head, time-sensitive classification head, and audio language model head, and the input feature representations.

### DETAILED DESCRIPTION OF THE INVENTION

### Overview

The following detailed description elaborates on the systems and techniques summarized in paragraphs [0017] through [0019], which address the technical deficiencies of conventional approaches described in the Background section.

The techniques herein relate to an improved system and process for determining a contextual understanding of time-series inputs generated by one or more sensor systems (e.g., acceleration, pressure, velocity, temperature, acoustic, optical, etc.). In some examples, the techniques herein may be applied to mono audio input, and/or may be applied to multi-channel audio input. In other words, the sensor data analyzed, processed, and classified according to the techniques herein may comprise a mono input (e.g., single channel or source), and/or may comprise a multi-channel input (e.g., a plurality of channels or sources).

In some examples, the sensor data analysis system 200 may be configured for mono audio input using a smaller language model. In this configuration, the audio perception encoder 208 processes single-channel audio data and produces audio embeddings, which are provided to a language model having between 100 million and 1 billion parameters (substantially smaller than the multi-billion parameter LLMs used in the multi-channel configuration). To compensate for the reduced model capacity, this configuration employs retrieval-augmented generation (RAG), in which the language model queries an external knowledge base during inference to retrieve relevant context about sound events, acoustic phenomena, and domain-specific information. The RAG approach enables the smaller language model to produce accurate and contextually rich outputs without requiring all relevant knowledge to be encoded in the model's parameters. This configuration is particularly advantageous for deployment on highly constrained edge devices (e.g., smartphones, IoT sensor nodes, wearable devices) where the computational budget does not support a multi-billion parameter LLM but where natural language scene description capability is still desired.

In some examples, the techniques herein relate to transforming or converting sensor data into spherical harmonics representations, which may reduce the computational expense and resource-intensive nature of analyzing and processing sensor data. In some examples, the techniques herein relate to facilitating simultaneous or near-simultaneous localization and classification of a single source or a plurality of sources of sensory (e.g., audio) data. For example, the techniques may be scalable or adaptable to various sensor formats or systems (e.g., binaural, bespoke sensor array, tetrahedral array, triangular array, etc.) by converting them to a common format. In some examples, the common format may be spherical harmonic based (e.g., ambisonics), wavefield synthesis based, or based on a virtual sound source representation derived from the Kirchhoff-Helmholtz integral theorem. The Kirchhoff-Helmholtz integral representation models the sound field as a superposition of virtual sound sources distributed on a boundary surface enclosing the sensor array, providing an alternative mathematical framework for spatial audio representation that may be advantageous for certain array geometries and deployment configurations.

In some examples, the sensor data analysis system 200 is configured to receive the sensor geometry data 203 as a text prompt input through the text instruction interface 218, as an alternative to or in addition to receiving the geometry data through the multi-channel sensor input interface 202. For example, a user or system may provide a natural language description of the sensor configuration (e.g., “four microphones in a square arrangement with 10 cm spacing on the top of a quadrotor drone”) or a structured text input specifying sensor positions (e.g., “mic1: (0,0,0), mic2: (0.1,0,0), mic3: (0,0.1,0), mic4: (0.1,0.1,0)”). The LLM 214 processes this text input and extracts the sensor geometry parameters, which are then provided to the dynamic-static interaction module 210. This text-prompt-based geometry input enables rapid reconfiguration of the system for new sensor arrangements without requiring programmatic changes to the sensor geometry data interface.

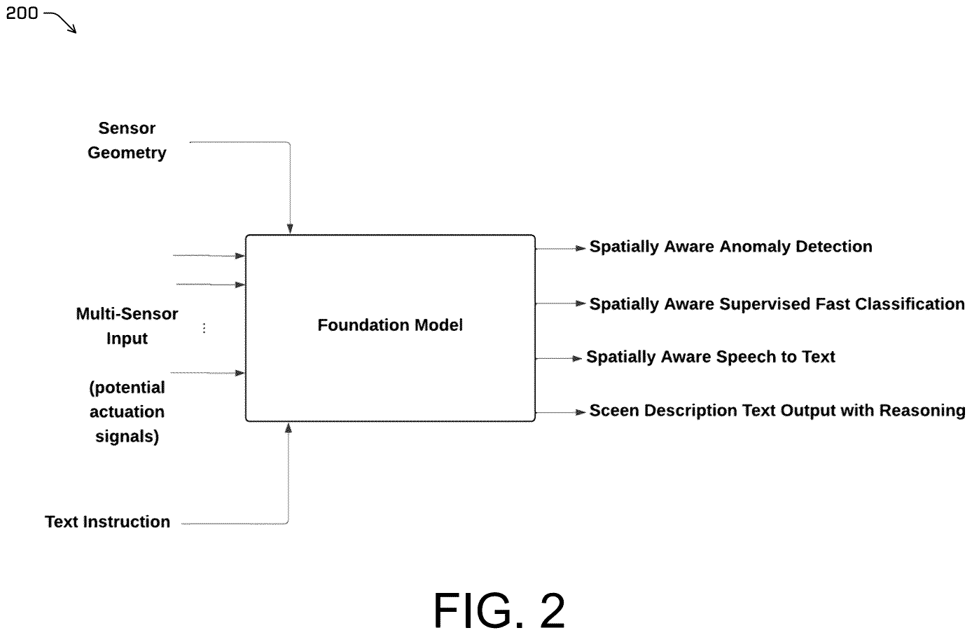

### System Architecture Overview (FIG. 2)

FIG. 2 illustrates a sensor data analysis system 200 configured to implement one or more of the techniques discussed herein, according to an embodiment of the present disclosure. The sensor data analysis system 200 includes a multi-channel sensor input interface 202, an audio feature extractor 204, a neural array-to-ambisonics converter 206, an audio perception encoder 208 based on a selective state space model, a dynamic-static interaction module 210, a projection layer 212, a large language model (LLM) 214, and a multi-headed output module 216. The sensor data analysis system 200 further includes a text instruction interface 218, a tokenizer 220, and a historical context buffer 222.

In operation, the multi-channel sensor input interface 202 receives time-series sensor data from a plurality of sensors. The sensors may include, but are not limited to, microphones (e.g., electret condenser microphones, MEMS microphones, piezoelectric microphones), hydrophones (e.g., piezoelectric hydrophones, fiber-optic hydrophones, or MEMS hydrophones for underwater acoustic sensing), accelerometers (e.g., MEMS accelerometers for vibration sensing, contact detection, or structural health monitoring), ultrasonic transducers (e.g., for nearfield sensing, sonar, or echolocation), optical vibration measurement devices (e.g., laser Doppler vibrometers), and actuation signal sensors (e.g., motor RPM encoders, drive current sensors, servo position encoders). Each sensor produces a time-series signal that is digitized at a sampling rate appropriate to the sensor modality (e.g., 16 kHz to 48 kHz for audio microphones, 1 kHz to 10 kHz for accelerometers, 40 kHz to 200 kHz for ultrasonic transducers).

The multi-channel sensor input interface 202 also receives sensor geometry data 203 specifying the spatial positions of the sensors in a coordinate system relative to the platform (e.g., vehicle, drone, robot, building) on which the sensors are mounted. The sensor geometry data 203 may be expressed in Cartesian coordinates (x, y, z) or spherical coordinates (r, theta, phi) for each sensor. For example, for an array of N microphones mounted on an autonomous vehicle, the sensor geometry data 203 may comprise a matrix of dimensions N×3, where each row specifies the three-dimensional position of one microphone relative to a reference point on the vehicle:
[mic_1_x, mic_1_y, mic_1_z]
[mic_2_x, mic_2_y, mic_2_z]
. . .
[mic_N_x, mic_N_y, mic_N_z]

As a specific, non-limiting example, consider an autonomous vehicle equipped with six microphones arranged in a non-uniform configuration on the vehicle exterior: a first microphone positioned at the front bumper center (0.0, 2.1, 0.8) meters relative to the vehicle rear axle center, a second microphone at the left A-pillar (−0.7, 1.5, 1.4) meters, a third microphone at the right A-pillar (0.7, 1.5, 1.4) meters, a fourth microphone at the left rear quarter panel (−0.8, −0.3, 0.9) meters, a fifth microphone at the right rear quarter panel (0.8, −0.3, 0.9) meters, and a sixth microphone at the rear bumper center (0.0, −0.5, 0.8) meters. This non-uniform, asymmetric array geometry provides spatially diverse sampling of the acoustic field around the vehicle. The sensor geometry data 203 for this configuration is provided as input to the dynamic-static interaction module 210, enabling the system to interpret the spatial cues in the multi-channel audio data in the context of this specific array geometry without any modification to the model architecture or parameters.

### Audio Feature Extractor

The audio feature extractor 204 receives the raw, digitized multi-channel sensor data from the multi-channel sensor input interface 202 and computes time-frequency representations for each channel. In some examples, the audio feature extractor 204 computes wavelet-based magnitude and phase features, which provide advantages over conventional spectrogram representations as described below.

In a conventional mel-spectrogram representation, the audio signal is segmented into overlapping frames (e.g., 25 ms frames with 10 ms hop), each frame is windowed (e.g., with a Hann window), and a Short-Time Fourier Transform (STFT) is computed to produce a complex-valued spectrogram. The magnitude of the complex spectrogram is then mapped to a mel-frequency scale by applying a bank of triangular filters, and a logarithmic compression is applied. This representation discards phase information entirely, which means that inter-channel phase differences—a primary cue for spatial localization—are lost.

In contrast, the wavelet-based feature representation employed by the audio feature extractor 204 preserves both magnitude and phase information. The audio feature extractor 204 applies a continuous wavelet transform (CWT) or a discrete wavelet transform (DWT) to each channel of the sensor data. The wavelet transform produces a complex-valued time-scale representation in which both magnitude and phase are retained. The magnitude component represents the energy distribution across time and frequency (or scale), while the phase component represents the instantaneous phase at each time-frequency point.

A specific and important technical advantage of the wavelet-based representation is that it provides adaptive time-frequency resolution: high temporal resolution at high frequencies and high frequency resolution at low frequencies. This adaptive resolution is particularly advantageous for processing sensor data from heterogeneous sensor types operating at different frequency ranges. For example, an accelerometer operating in the range of 0.1 Hz to 1,000 Hz and a microphone operating in the range of 20 Hz to 20,000 Hz can both be represented in the wavelet domain with appropriate resolution at their respective frequency ranges, without the fixed-resolution compromise imposed by the STFT.

Furthermore, the wavelet-based representation enables cross-frequency transfer learning. Because the wavelet transform decomposes the signal into scale-invariant basis functions, features learned at one frequency scale can transfer to another frequency scale. This is a structural improvement to the model itself: by presenting training data in a scale-invariant representation, the model's learned convolutional or attention weights generalize across frequency ranges without retraining. For example, a model trained on acoustic data in the audible frequency range (20 Hz to 20,000 Hz) can be applied, with reduced or no additional training, to ultrasonic sensor data (e.g., 40 kHz to 200 kHz) because the wavelet-domain features at different scales share structural similarities.

In some examples, the audio feature extractor 204 concatenates the wavelet-based magnitude representation and the wavelet-based phase representation along a channel dimension to produce a multi-channel feature tensor for each sensor channel. In some examples, the audio feature extractor 204 further computes a mel-log spectrum representation and concatenates it with the wavelet-based features. The resulting feature tensor for each audio frame has a structure analogous to a multi-channel image, with time along one axis, frequency (or scale) along another axis, and the different feature types (wavelet magnitude, wavelet phase, mel-log spectrum) along the channel axis. This image-like structure enables the use of architectures originally developed for image processing, adapted for audio applications.

### Neural Array-to-Ambisonics Conversion

In some examples, the sensor data analysis system 200 includes a neural array-to-ambisonics converter 206 that converts multi-channel audio data from an arbitrary array geometry to a standardized spatial representation. The system is designed to cover both dedicated spatial microphone formats (e.g., first-order ambisonics (FOA) microphones, higher-order ambisonics microphones) and general microphone setups with arbitrary geometries (e.g., tetrahedral arrays, triangular arrays, binaural configurations, linear arrays, and irregular non-uniform arrays). For dedicated spatial microphones that already capture data in a spherical harmonic format, the neural array-to-ambisonics converter 206 may pass the data through with minimal processing or apply a learned correction for non-ideal microphone characteristics. For general microphone setups, the neural array-to-ambisonics converter 206 converts the multi-channel data to a standardized spatial representation. The main architectural difference between these two input pathways lies in how the spatial feature matrices are extracted: dedicated spatial microphones provide spatial cues directly in the spherical harmonic domain, while general microphone setups require the extraction of spatial cues (e.g., inter-channel phase differences, intensity vectors) that are dependent on the specific microphone array geometry. In some examples, this standardized spatial representation is an ambisonics representation (e.g., B-format), which represents the sound field using spherical harmonic basis functions.

The conversion from an arbitrary array geometry to ambisonics may be performed using an analytical approach or a data-driven approach. In the analytical approach, the neural array-to-ambisonics converter 206 applies a matrix transformation that is computed from the known sensor positions and the spherical harmonic basis functions evaluated at those positions. This analytical approach works well when the sensors are arranged in a configuration that is compatible with the target ambisonics order (e.g., a sufficient number of sensors distributed with adequate spatial coverage).

In the data-driven approach, the neural array-to-ambisonics converter 206 comprises a machine-learned model (e.g., a neural network) that is trained to convert multi-channel audio data from a specific array geometry to ambisonics. The training data for this model may be generated using the hybrid simulation pipeline described below, in which synthetic spatial audio scenes are rendered simultaneously at the specific array positions and in the ambisonics domain. The machine-learned model learns to perform the conversion by optimizing a loss function that measures the difference between its output and the ground-truth ambisonics representation.

The data-driven approach provides a specific technical advantage over the analytical approach: it can account for non-ideal characteristics of the array, including acoustic scattering by the platform on which the sensors are mounted. When microphones are mounted on a vehicle, drone, or robot, the body of the platform causes acoustic scattering (reflection, diffraction, and diffusion) that modifies the sound field at the microphone positions. This scattering is frequency-dependent and geometry-dependent. A conventional analytical beamformer does not account for this scattering and therefore produces inaccurate spatial estimates. The data-driven neural array-to-ambisonics converter 206, by contrast, is trained on data that includes the scattering effects of the specific platform geometry (as simulated by the hybrid simulation pipeline), and therefore learns to compensate for these scattering effects. This represents a structural improvement to the conversion model itself, not merely an improvement in output quality from better training data: the model's internal parameters encode a learned representation of the platform's acoustic transfer function, which enables accurate spatial processing on platforms where analytical approaches fail.

### Audio Perception Encoder Based on Selective State Space Model

The audio perception encoder 208 receives the feature tensor from the audio feature extractor 204 (or from the neural array-to-ambisonics converter 206, if employed) and encodes it into audio embeddings. In some examples, the audio perception encoder 208 is based on a selective state space model (SSM) architecture, such as a bidirectional Mamba architecture, which provides specific technical advantages over conventional transformer-based encoders as described below. In other examples, the audio perception encoder 208 may be implemented using an Audio Spectrogram Transformer (AST), a Self-Supervised Audio Spectrogram Transformer (SSAST), or a hybrid architecture combining state space model and transformer components. The choice of encoder architecture may be selected based on the computational budget of the target deployment platform and the specific requirements of the application. The selective SSM architecture is preferred for edge deployment scenarios due to its linear computational complexity, while transformer-based variants may be preferred for cloud deployment scenarios where quadratic complexity is acceptable and self-attention may provide stronger performance on shorter sequences.

A conventional transformer encoder processes an input sequence using self-attention mechanisms that compute pairwise interactions between all elements of the sequence. The computational complexity of self-attention is O(n\hat{ }2) with respect to the input sequence length n, because each element attends to every other element. For audio data, which typically involves long sequences (e.g., at a frame rate of 100 frames per second, a 10-second audio segment produces 1,000 frames, and at a feature dimension of 128, the self-attention computation involves 1,000×1,000=1,000,000 pairwise interactions per attention head), this quadratic complexity imposes significant computational cost, particularly on edge devices with limited compute budgets.

The selective state space model employed by the audio perception encoder 208 addresses this technical limitation by processing the input sequence with linear computational complexity O(n) with respect to the input sequence length. The selective SSM achieves this by maintaining a fixed-dimensional hidden state that is updated recurrently as each element of the input sequence is processed, rather than computing pairwise interactions between all elements. Specifically, the selective SSM defines a linear dynamical system:

$$h ( t ) = A * h ( t - 1 ) + B * x ( t )$$

$$y ( t ) = C * h ( t ) + D * x ( t )$$

where h(t) is the hidden state at time step t, x(t) is the input at time step t, y(t) is the output at time step t, and A, B, C, D are learned parameter matrices. The term “selective” refers to the fact that the parameters B and C are functions of the input x(t), enabling the model to selectively attend to or ignore input elements based on their content. This input-dependent parameterization is a structural improvement over classical state space models (which use fixed B and C parameters) and enables the selective SSM to perform content-based reasoning while maintaining linear complexity.

The selective SSM architecture provides a specific technical improvement for audio processing compared to attention-based transformers. Audio signals exhibit strong temporal dependencies at multiple time scales (e.g., a siren waveform has a modulation period of 1-4 seconds, while a speech phoneme has a duration of 50-200 milliseconds, and a transient impact sound has a duration of 1-50 milliseconds). The recurrent structure of the SSM naturally maintains information about these temporal dependencies in its hidden state, without requiring explicit positional encodings or relative attention biases that transformer architectures typically require. Furthermore, the linear complexity of the SSM enables processing of longer audio contexts (e.g., 30 seconds or more) that would be prohibitively expensive with quadratic-complexity attention.

In some examples, the audio perception encoder 208 comprises a stack of selective SSM blocks, where each block includes: (a) a linear projection layer that maps the input to a higher-dimensional space; (b) a selective SSM layer that processes the projected input with input-dependent state transitions; (c) a gating mechanism that applies an element-wise nonlinearity (e.g., SiLU activation) to control information flow; and (d) a residual connection from the block input to the block output. The number of blocks, the hidden state dimension, and the projection dimension are architectural hyperparameters that determine the model capacity and computational cost.

The output of the audio perception encoder 208 is a sequence of audio embeddings, where each embedding is a fixed-dimensional vector (e.g., 768 dimensions or 1024 dimensions) that encodes the acoustic content and spatial information present in the corresponding time frame of the input sensor data. These audio embeddings serve as input to the dynamic-static interaction module 210 and, ultimately, to the multi-headed output module 216.

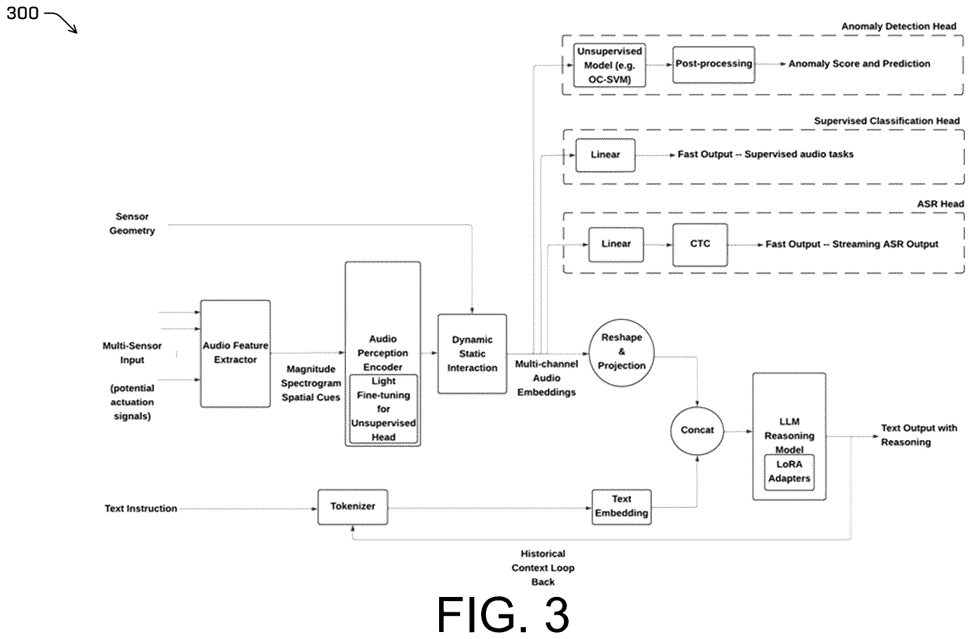

### Dynamic-Static Interaction Module (FIG. 3)

The dynamic-static interaction module 210 receives two inputs: (a) the time-variant audio embeddings from the audio perception encoder 208, which represent the dynamic features of the acoustic scene that change over time; and (b) the time-invariant sensor geometry data 203 from the multi-channel sensor input interface 202, which represents the static features of the sensor configuration that remain constant during a processing session.

The dynamic-static interaction module 210 fuses these dynamic and static features to produce geometry-conditioned audio embeddings. This fusion is a structural improvement to the model architecture that enables the system to interpret the spatial cues in the audio embeddings in the context of the specific sensor array geometry. Without this module, the model would need to be trained separately for each sensor array geometry, or would need to learn the geometry implicitly from the training data, which would require prohibitively large training datasets covering all possible geometries.

In some examples, the time-invariant static features provided to the dynamic-static interaction module 210 include, in addition to the sensor positions, one or more of: (a) a surface geometry representation of the platform on which the sensors are mounted (e.g., a three-dimensional mesh, a set of surface normal vectors, or parameterized enclosure dimensions), which enables the module to account for platform-induced acoustic scattering effects; (b) atmospheric parameters including an atmospheric thermal gradient profile, which affects the curvature of acoustic propagation paths; (c) sound speed or its contributing variables including temperature, humidity, and molecular composition of the propagation medium, which affect wavelength-dependent spatial cue interpretation; and (d) terrain or ground surface parameters (e.g., surface impedance, surface type) that affect ground-reflected propagation. These additional static features enable the dynamic-static interaction module 210 to condition the audio embeddings not only on the sensor array geometry but also on the physical propagation environment, improving the accuracy of spatial localization and classification in diverse deployment conditions.

In some examples, the dynamic-static interaction module 210 implements the fusion using a cross-attention mechanism. In the cross-attention mechanism, the audio embeddings serve as the query (Q) and the sensor geometry features serve as the key (K) and value (V). Specifically:

$$Q = W\_Q * E\_audio ( audio embeddings projected to query space )$$

$$K = W\_K * E\_geometry ( geometry features projected to key space )$$

$$V = W\_V * E\_geometry ( geometry features projected to value space )$$

$$Attention = softmax ( Q * K \hat{} T / sqrt ( d\_k ) ) * V$$

where E_audio is the audio embedding tensor of dimensions [T, d_model] (T time frames, d_model embedding dimension), E_geometry is the geometry feature tensor of dimensions [N, d_geo] (N sensors, d_geo geometry feature dimension), W_Q, W_K, W_V are learned projection matrices, and d_k is the dimension of the key space. Because the geometry features E_geometry have a different number of elements (N sensors) than the audio embeddings (T time frames), the geometry features are replicated or broadcast to produce compatible dimensions for the attention computation.

The cross-attention mechanism enables each audio embedding (at each time frame) to selectively attend to the geometry features of different sensors. This is a structurally different computation than self-attention (where audio embeddings attend to other audio embeddings) and different from simple concatenation (where geometry features are appended to audio embeddings without interaction). The cross-attention enables the model to learn sensor-geometry-dependent spatial cue extraction: for example, the model may learn that for a specific pair of sensors with a particular inter-element spacing, the inter-channel phase difference at a particular frequency corresponds to a particular angle of arrival. This learned correspondence is embedded in the attention weights and is specific to the geometry, enabling the model to adapt to arbitrary geometries without retraining.

In some examples, the dynamic-static interaction module 210 implements the fusion using a linear layer with concatenation. In this approach, the sensor geometry features are encoded by a linear layer into a geometry embedding of the same dimension as the audio embeddings. The geometry embedding is then concatenated with each audio embedding along the feature dimension. A subsequent linear layer maps the concatenated representation back to the original embedding dimension. This approach is computationally less expensive than cross-attention but may be less expressive for complex geometry-dependent spatial cue extraction.

In some examples, the dynamic-static interaction module 210 implements the fusion using both cross-attention and linear concatenation in a multi-stage pipeline. For example, a first stage may apply cross-attention to capture fine-grained geometry-dependent spatial cues, and a second stage may apply linear concatenation to integrate additional geometry features (e.g., sensor type identifiers, frequency response parameters).

In alternative embodiments, the dynamic-static interaction module 210 operates on intermediate representations within the audio perception encoder 208 rather than on the final encoder output, enabling geometry conditioning at multiple stages of the encoding process.

As a specific, non-limiting example illustrating the operation of the dynamic-static interaction module 210, consider the six-microphone autonomous vehicle configuration described in paragraph [0045]. The audio perception encoder 208 produces audio embeddings of dimension [T, 768] for T time frames. The sensor geometry data 203 is a matrix of dimension [6, 3] specifying the (x, y, z) positions of the six microphones. The dynamic-static interaction module 210 projects the geometry data through a learned linear layer to produce a geometry embedding of dimension [6, 768]. The cross-attention mechanism then computes attention weights of dimension [T, 6], where each entry indicates how strongly a particular audio embedding attends to a particular sensor's geometry. The resulting geometry-conditioned audio embeddings encode not only what sounds are present (from the audio perception encoder) but also how the sounds relate to the spatial configuration of the sensors, enabling downstream modules to perform accurate spatial localization.

### Integration of Actuation Signals

In some examples, the sensor data analysis system 200 receives actuation signals from the platform on which the sensors are mounted. Actuation signals include, but are not limited to: motor RPM signals from electric motors (e.g., drive motors of an electric vehicle, rotor motors of a drone, joint motors of a robot), drive current signals from motor controllers, servo position signals from actuators, wheel speed signals from wheel speed sensors, and throttle position signals from throttle controllers.

Actuation signals provide information about the self-generated noise of the platform. For example, a drone generates significant acoustic noise from its rotors, and the spectral content of this rotor noise is directly related to the rotor RPM. By providing the rotor RPM as an additional input to the model, the system can more accurately distinguish between rotor noise (self-noise) and external acoustic events (e.g., the sound of another aircraft approaching, a person shouting). Similarly, an autonomous vehicle generates road noise, tire noise, and motor noise that are correlated with vehicle speed, throttle position, and road surface; by providing these actuation signals as inputs, the system can more accurately detect external events such as emergency vehicle sirens or collision sounds.

In some examples, the actuation signals are converted to time-frequency representations by the audio feature extractor 204, using the same wavelet-based feature extraction process described above. The resulting actuation feature tensors are concatenated with the audio feature tensors along the channel dimension before being input to the audio perception encoder 208. This concatenation enables the encoder to jointly process acoustic sensor data and actuation data in a unified representation.

In some examples, the actuation signals are provided as conditioning inputs to the dynamic-static interaction module 210, alongside the sensor geometry data 203. In this approach, the actuation signals are treated as additional static or quasi-static features that condition the interpretation of the audio embeddings. For example, the rotor RPM at a given time instant determines the expected spectral content of the self-noise at that time instant, and the dynamic-static interaction module 210 can use this information to suppress self-noise components in the audio embeddings.

This integration of actuation signals as model inputs represents a structural improvement to the model architecture compared to conventional approaches that use actuation signals for post-processing noise cancellation. In a conventional approach, a noise cancellation filter is applied to the raw audio before the audio is processed by a classifier. This sequential approach requires the noise cancellation filter to make hard decisions about which components of the audio are noise and which are signal, potentially removing signal components that overlap spectrally with the noise. In the approach disclosed herein, the actuation signals are provided as input to the encoder, which learns to jointly model the noise and signal components within a single, end-to-end-trained architecture. The encoder's internal representations can maintain information about both the noise and signal components, and the downstream task heads can make soft, probabilistic decisions about the contribution of each component to the final classification or description.

### Multi-Headed Output Architecture (FIG. 3)

The multi-headed output module 216 receives the geometry-conditioned audio embeddings from the dynamic-static interaction module 210 (or, in some examples, from the projection layer 212 after further processing) and produces outputs through three specialized output heads: an anomaly detection head 216a, a time-sensitive classification head 216b, and an audio language model (ALM) head 216c. This multi-headed architecture is a structural improvement to the model architecture that enables a single shared encoder backbone to serve multiple downstream tasks simultaneously, eliminating the need for multiple independent models.

The anomaly detection head 216a is configured to detect deviations from a learned baseline acoustic profile. In some examples, the anomaly detection head 216a comprises a shallow neural network (e.g., one or two fully connected layers) that receives the geometry-conditioned audio embeddings and produces an anomaly score for each time frame and each spatial direction. The anomaly score is a scalar value indicating the degree to which the acoustic content at that time frame and spatial direction deviates from the expected baseline. The anomaly detection head 216a is trained using reconstruction-based or contrastive learning objectives, in which the head learns to reconstruct normal acoustic patterns and assigns high anomaly scores to patterns that deviate from the learned normal distribution.

The time-sensitive classification head 216b is configured to classify acoustic events with low latency (e.g., less than 50 milliseconds from event onset to classification output) for safety-critical applications. In some examples, the time-sensitive classification head 216b comprises a lightweight neural network (e.g., one or two convolutional layers followed by a fully connected layer) that receives the geometry-conditioned audio embeddings and produces classification probabilities for a set of predefined classes. The predefined classes may include, but are not limited to:
Emergency vehicle siren classes: wail siren, yelp siren, hi-lo siren, air horn, electronic siren, rumbler siren
Impact/collision classes: low-intensity collision (e.g., pedestrian contact), moderate collision (e.g., fender bender), high-intensity collision (e.g., broadside), glass breakage
Human safety classes: scream, shout, distress vocalization, verbal command (e.g., “stop”), gunshot
Mechanical failure classes: bearing failure, belt slip, cavitation, pressure release
Vehicle operation classes: horn, tire screech, engine rev, braking

Each class in the time-sensitive classification head 216b is associated with a spatial direction estimate (azimuth and elevation angles) and a distance estimate, in addition to a classification confidence score. For example, the output of the time-sensitive classification head 216b for a given time frame may be:
{class: “wail_siren”, confidence: 0.94, azimuth: 45.2 degrees,
elevation: −2.1 degrees, distance: 185 meters, approach_rate: 22 m/s}

The audio language model (ALM) head 216c is configured to produce natural language descriptions of the acoustic scene, including speech-to-text transcription, by use of a large language model (LLM) 214. The ALM head 216c receives the geometry-conditioned audio embeddings, which are mapped to the LLM input space by the projection layer 212. The projection layer 212 is a learned linear transformation that maps the audio embedding dimension to the LLM token embedding dimension. The mapped audio embeddings are concatenated with text embeddings from the tokenizer 220 (which processes any text instructions from the text instruction interface 218) and provided as input to the LLM 214.

The LLM 214 is a pre-trained language model (e.g., a model from the LLaMA, Qwen, or similar family) that has been adapted for audio-language tasks through parameter-efficient fine-tuning. Specifically, the LLM 214 is fine-tuned using Low-Rank Adaptation (LoRA), in which low-rank adapter matrices are inserted into the attention layers of the LLM. During fine-tuning, only the LoRA adapter parameters and the projection layer parameters are trained; the pre-trained LLM parameters remain frozen. This approach provides a specific technical advantage: it enables the system to use the language understanding and generation capabilities of a large pre-trained LLM without the computational cost of full fine-tuning, and without the risk of catastrophic forgetting of the LLM's pre-trained knowledge.

The LoRA fine-tuning of the LLM 214 represents a structural improvement to the model architecture in several respects. First, by keeping the LLM frozen and training only the low-rank adapters, the system achieves a separation of concerns: the LLM encodes general language knowledge, while the adapters encode audio-specific and task-specific knowledge. This separation enables the system to be updated for new audio tasks or new deployment configurations by training only the adapters, without modifying the LLM. Second, the low-rank structure of the adapters constrains the adaptation to a low-dimensional subspace of the LLM's parameter space, which acts as an implicit regularizer and prevents overfitting to small audio-language training datasets. Third, the adapter parameters constitute a small fraction of the total LLM parameters, enabling storage and deployment of multiple task-specific adapter configurations alongside a single shared LLM.

In some examples, the LLM 214 receives as input the concatenated audio embeddings and text embeddings, and generates an output text sequence that describes the acoustic scene, including identification and spatial localization of multiple simultaneous sound sources, speech transcription, and environmental characterization.

In some examples, the output from the LLM 214 is stored in the historical context buffer 222 and used as additional context for subsequent processing iterations. This enables the system to maintain temporal continuity in its scene descriptions and to track the evolution of acoustic events over time. For example, if the system detected a siren at 300 meters in a previous iteration and now detects a siren at 250 meters, the historical context enables the LLM 214 to describe the siren as “continuing to approach” rather than as a newly detected event.

The multi-headed architecture provides a specific technical advantage in terms of computational efficiency. Because the anomaly detection head 216a, the time-sensitive classification head 216b, and the ALM head 216c all operate on the same shared audio embeddings produced by the audio perception encoder 208 and the dynamic-static interaction module 210, the total computational cost of running all three heads is substantially less than the cost of running three separate, independent models. The shared encoder backbone performs the computationally expensive feature extraction and spatial processing once, and each head performs only lightweight, task-specific processing on top of the shared embeddings. In some examples, the total parameter count of the sensor data analysis system 200 (including the encoder, the dynamic-static interaction module, the projection layer, the LLM with LoRA adapters, and all three output heads) is comparable to the parameter count of a single-channel speech-to-text engine, enabling deployment on edge devices with the same compute budget as a conventional speech recognizer.

### Hierarchical Class Labels

In some examples, the techniques herein further relate to determining (e.g., assigning) one or more classes with labels based at least in part on physical characteristics associated with the sound generation mechanism, in addition to expected contextual names. In some examples, the classes are organized in a hierarchical taxonomy, in a hierarchical taxonomy.

The hierarchical class label taxonomy organizes sound events at multiple levels of specificity. At the highest level (Level 1), sound events are classified into broad categories based on the physical mechanism of sound generation:
Continuous mechanical: sounds generated by rotating or reciprocating machinery (e.g., motors, fans, pumps, compressors)
Impulsive mechanical: sounds generated by impacts or transient mechanical events (e.g., collisions, hammering, breakage)
Aerodynamic: sounds generated by fluid flow (e.g., wind, ventilation, propeller wash, tire noise)
Vocalization: sounds generated by human or animal vocal tracts (e.g., speech, shouts, screams, animal calls)
Electronic/tonal: sounds generated by electronic devices (e.g., sirens, alarms, beeps, music)

At the second level (Level 2), each Level 1 category is subdivided into more specific categories. For example, within the “Electronic/tonal” category:
Emergency siren: wail, yelp, hi-lo, air horn, electronic, rumbler
Alarm: fire alarm, burglar alarm, car alarm, smoke detector
Signal: horn, whistle, bell, buzzer

At the third level (Level 3), each Level 2 category may be further subdivided. For example, within “Emergency siren>wail”:
American wail (Federal Signal, Whelen Engineering patterns)
European hi-lo (two-tone alternating)
Custom/regional variants

Each class at each level is associated with a set of physical attributes that describe the expected acoustic signature:
Spectral centroid range (e.g., wail siren: 800 Hz to 1,600 Hz fundamental)
Modulation characteristics (e.g., wail siren: frequency sweep over 1-4 second period)
Temporal pattern (e.g., yelp siren: rapid alternation, 2-4 cycles per second)
Expected source power level (e.g., emergency siren: 100-120 dB at 3 meters)
Typical spatial behavior (e.g., emergency siren on vehicle: moving source, approach speeds 10-40 m/s)

The hierarchical class label taxonomy enables the system to provide outputs at different levels of specificity depending on the confidence of the classification and the requirements of the application. For a safety-critical application such as emergency vehicle detection, the system may provide a high-confidence Level 2 classification (e.g., “emergency siren”) with a lower-confidence Level 3 classification (e.g., “probably wail, possibly yelp”). For a non-safety-critical application such as environmental noise monitoring, the system may provide Level 1 classifications (e.g., “continuous mechanical”) with confidence scores. The labels include spatial attributes and may be expressed in a compact format that combines the event class, spatial direction, distance, and motion characteristics. For example, a label may be expressed as: “Footsteps, 30 degrees, 7 meters, approaching 3 mph”—indicating a detected footstep event at 30 degrees azimuth, 7 meters distance, with an approach rate of 3 miles per hour. In a structured format, such a label may be expressed as:
{class_L1: “impulsive_mechanical”, class_L2: “footsteps”,
class_L3: “walking_human”, confidence_L2: 0.91, confidence_L3: 0.78,
azimuth: 30.0, elevation: −5.0, distance_m: 7, speed_m_s: 1.3,
direction: “approaching”}
   As another example, a more complex label for an emergency vehicle:
{class_L1: “electronic_tonal”, class_L2: “emergency_siren”,
class_L3: “wail”, confidence_L2: 0.97, confidence_L3: 0.82,
azimuth: 45.2, elevation: −2.1, distance_m: 185, speed_m_s:22,
source_level_dB: 112}

### Spatial Audio Cues and Spectrogram Concatenation

Additionally or alternatively, the techniques herein may concatenate (e.g., combine or otherwise merge) spatial audio cues with the wavelet-based and/or spectrogram features. For audio data converted or transformed to an ambisonics format, spatial cues may be determined or associated with an intensity vector matrix. The intensity vector matrix represents, at each time-frequency point, the direction from which acoustic energy is arriving. This is computed from the ambisonics channels as:

$$I ( t , f ) = Re \{ P ( t , f ) * conj ( V ) t , f ) ) \}$$

where P(t, f) is the omnidirectional (W-channel) ambisonics signal at time t and frequency f, and V(t, f) is the velocity vector (X, Y, Z channels) at time t and frequency f. The resulting intensity vector I(t, f) has three components (x, y, z) that represent the direction of energy flow.

For binaural or otherwise irregular sensor systems or structures, sine or cosine transformations of inter-sensor phase differences may be applied to and/or determined for the audio data. Specifically, for each pair of sensors (i, j) and each frequency bin f, the inter-sensor phase difference (IPD) is computed as:

$$IPD\_ij ( t , f ) = angle ( X\_i ( t , f ) * conj ( X\_j ( t , f ) ) )$$

where X_i and X_j are the complex STFT or wavelet coefficients at sensors i and j. The cosine and sine of the IPD are computed:

$$cos\_IPD \_ij ( t , f ) = cos ( IPD\_ij ( t , f ) )$$

$$sin\_IPD \_ij ( t , f ) = sin ( IPD\_ij ( t , f ) )$$

These cosine and sine IPD features are concatenated with the magnitude features along the channel dimension. This representation preserves the spatial information in a form that is continuous and differentiable, enabling gradient-based training of the audio perception encoder 208.

The encoder 208 outputs multi-channel audio embeddings, which may be reshaped and/or projected such that they can be concatenated with text or other data embeddings. The projection layer 212 performs this reshaping and projection, mapping the audio embedding space to the text embedding space of the LLM 214.

### Training Data Generation: Hybrid Simulation Pipeline

The sensor data analysis system 200 includes a training data generation subsystem that uses a hybrid simulation pipeline to generate physically accurate, multi-channel synthetic training data at scale. The hybrid simulation pipeline addresses the technical deficiency described in paragraph [0011] by providing a means to generate multi-channel training data for arbitrary sensor array geometries and deployment environments.

The hybrid simulation pipeline combines two complementary acoustic simulation approaches: (a) a wave-based simulation using numerical methods that solve the acoustic wave equation, such as Finite-Difference Time-Domain (FDTD), Boundary Element Method (BEM), or Finite Element Method (FEM), which accurately model wave phenomena including diffraction, scattering, and interference at wavelengths comparable to or larger than the geometric features of the scene; and (b) a ray-based simulation using high-frequency asymptotic methods, such as Geometrical Acoustics (GA), Image Source Method (ISM), or beam tracing, which efficiently model reflection, absorption, and propagation at wavelengths much smaller than the geometric features of the scene.

In some examples, the wave-based simulation employs a Finite-Difference Time-Domain (FDTD) method, which operates by discretizing the acoustic wave equation on a spatial grid and advancing the solution in time steps. In other examples, the wave-based simulation employs a Boundary Element Method (BEM), which solves the wave equation on the surfaces of objects rather than throughout the volume, or a Finite Element Method (FEM), which discretizes the domain into elements of variable size. Each of these wave-based methods accurately models all wave phenomena, including diffraction around the platform body, scattering from surface features, and interference patterns between direct and reflected wavefronts. However, wave-based methods are computationally expensive at high frequencies because the spatial discretization must be fine enough to resolve the shortest wavelength of interest (typically at least 6-10 grid points per wavelength for FDTD, or comparable mesh density for BEM and FEM). For this reason, the wave-based simulation is used primarily for the lower frequency range (e.g., below a crossover frequency determined by the computational budget and the geometric feature sizes of the platform).

In some examples, the ray-based simulation employs a Geometrical Acoustics (GA) approach, which operates by tracing rays from sound sources through the environment, computing reflections from surfaces, and accumulating the contributions of all rays that reach each sensor position. In other examples, the ray-based simulation employs an Image Source Method (ISM), which models reflections as virtual sound sources positioned at mirror-image locations relative to reflecting surfaces, or a beam tracing method, which traces volumetric beams or cones rather than individual rays to improve computational efficiency while maintaining accuracy. Each of these ray-based methods is computationally efficient at high frequencies (where the number of rays, image sources, or beams required is independent of frequency) and accurately models specular reflection, absorption, and long-distance propagation including frequency-dependent atmospheric absorption computed in accordance with ISO 9613-1 (Acoustics—Attenuation of sound during propagation outdoors). However, ray-based methods do not accurately model diffraction, scattering, or interference at wavelengths comparable to geometric feature sizes. For this reason, the ray-based simulation is used primarily for the higher frequency range (e.g., above the crossover frequency).

The hybrid simulation pipeline combines the wave-based and GA results in the frequency domain. Below the crossover frequency, the wave-based results are used. Above the crossover frequency, the ray-based results are used. In a transition band around the crossover frequency, the two results are blended using a smooth crossover function to avoid discontinuities. The resulting hybrid impulse response captures both low-frequency wave phenomena (from the wave-based solver) and high-frequency ray phenomena (from the ray-based solver) for each source-to-sensor path.

The hybrid simulation pipeline receives the following inputs: (a) a geometric model of the platform (e.g., a CAD model or mesh representation of the vehicle, drone, or robot body); (b) the sensor positions on the platform; (c) the acoustic properties of the platform surfaces (e.g., impedance, absorption coefficient as a function of frequency); (d) a description of the environment (e.g., building geometry, ground surface type, atmospheric conditions); and (e) the positions, orientations, and source characteristics of one or more sound sources. From these inputs, the pipeline computes a set of multi-channel impulse responses that describe how sound propagates from each source to each sensor through the environment and around the platform.

To generate training data, the pipeline convolves clean, single-channel source audio signals with the computed multi-channel impulse responses, producing synthetic multi-channel recordings as they would be captured by the sensor array on the platform in the simulated environment. Multiple source signals can be convolved with impulse responses corresponding to different source positions and combined to create complex acoustic scenes with multiple simultaneous sources.

### Data Augmentation Techniques

In some examples, the training data generation subsystem applies data augmentation techniques to increase the diversity and realism of the synthetic training data. The data augmentation techniques include, but are not limited to:
(a) Environmental noise superposition: Adding recorded or synthesized ambient noise (e.g., wind noise, traffic noise, urban soundscapes, industrial noise) to the synthetic multi-channel recordings. The ambient noise may be spatialized using the same simulation pipeline to ensure consistent spatial characteristics.
(b) Source position randomization: Varying the positions, orientations, and trajectories of sound sources across training examples. For example, an emergency vehicle siren source may be placed at random azimuths, distances, and approach trajectories to ensure the model generalizes across spatial configurations.
(c) Atmospheric propagation effects: Applying frequency-dependent atmospheric absorption in accordance with ISO 9613-1, sound speed gradients (due to temperature and humidity variations), and wind effects to the simulated propagation paths.
(d) Ground surface variation: Modeling different ground surface types (e.g., asphalt, grass, water, gravel, concrete) with their respective acoustic impedances and absorption characteristics.
(e) Sensor hardware modeling: Applying modeled transfer functions representing the frequency response, self-noise floor, sensitivity, and harmonic distortion characteristics of specific sensor hardware. This augmentation enables the model to generalize across different sensor hardware without retraining.
(f) Electrical interference simulation: Superimposing modeled electrical interference patterns (e.g., 50/60 Hz hum, electromagnetic interference from vehicle electronics) on the sensor data.
(g) Platform self-noise simulation: For platforms with actuators (e.g., drones with rotors, vehicles with motors), generating self-noise correlated with the actuation signals and adding it to the sensor data at the appropriate spatial positions.

Each augmentation is applied with randomized parameters drawn from distributions that reflect the expected range of real-world conditions. The combination of physics-based simulation with extensive data augmentation enables the training data generation subsystem to produce training datasets of arbitrary size that capture the variability of real-world acoustic environments.

### Simulation-Driven Geometry-Agnostic Training

The hybrid simulation pipeline serves a dual strategic purpose in the training methodology of the sensor data analysis system 200. During pre-training of the audio perception encoder 208, the simulation pipeline generates training data across a large and diverse set of virtual sensor array geometries, platform enclosure shapes, and deployment environments. Specifically, the pipeline is configured to iterate over a combinatorial space of array configurations including variations in: (a) the number of sensors (e.g., from one sensor to sixteen or more sensors); (b) the spatial arrangement of sensors (e.g., linear, circular, planar, tetrahedral, triangular, irregular, and randomly generated geometries); (c) the inter-element spacing (e.g., from 1 centimeter to 2 meters); (d) the platform enclosure geometry (e.g., passenger vehicles, commercial trucks, drones of various form factors, humanoid robots, quadruped robots, building-mounted installations, handheld devices, and wearable devices); and (e) the acoustic surface properties of the enclosure (e.g., materials ranging from acoustically reflective metals to acoustically absorptive polymer housings). By exposing the audio perception encoder 208 and the dynamic-static interaction module 210 to synthetic training data spanning this diverse combinatorial space during pre-training, the model learns to extract spatial information from arbitrary sensor configurations without requiring retraining for each new configuration. This simulation-driven diversity during pre-training is the mechanism by which the sensor data analysis system 200 achieves hardware-geometry-agnostic operation.

A specific and critical advantage of generating training data through physics-based simulation is that the simulation pipeline produces exact, error-free spatial ground truth labels for every sound source in every training example. Because the simulation pipeline programmatically controls the positions, orientations, trajectories, and source characteristics of all sound sources, the ground truth labels—including azimuth, elevation, distance, trajectory, velocity, and source class—are known with perfect precision. This is in contrast to real-world training data, where spatial ground truth must be obtained through manual annotation (which is subjective, labor-intensive, and imprecise, particularly for distance and elevation estimates), or through auxiliary measurement systems (e.g., GPS-tracked vehicles, motion capture systems) that introduce their own measurement uncertainties and are impractical to deploy at scale. The perfect spatial ground truth available from simulation enables the audio perception encoder 208 and the output heads 216a-216c to be trained with precise supervision signals for spatial localization, which directly improves the localization accuracy of the deployed system. Furthermore, the simulation pipeline can generate ground truth at arbitrary temporal resolution (e.g., per-frame source positions for moving sources), enabling training of the system's source tracking capabilities with continuous trajectory labels that would be prohibitively expensive to annotate manually.

The simulation pipeline enables a substantial amplification of the effective training dataset size relative to the quantity of source audio recordings. Because the pipeline takes single-channel source audio signals as input and convolves them with physics-based multi-channel impulse responses computed for diverse spatial configurations, a single source recording (e.g., a siren recording, a speech utterance, a machine noise recording) can be used to generate a large number of distinct multi-channel training examples by varying the source position, array geometry, platform enclosure, environmental conditions, and augmentation parameters. For example, a library of source recordings comprising on the order of tens of thousands of hours of single-channel audio can be processed through the simulation pipeline to generate on the order of one million or more hours of spatially diverse, multi-channel training data with exact spatial labels. This scale amplification directly addresses the data scarcity problem identified in paragraph [0011] and is a primary enabler of the foundation model approach, in which the audio perception encoder 208 is pre-trained on a sufficiently large and diverse dataset to develop general acoustic understanding before being fine-tuned for specific deployment configurations.

The wave-based component of the hybrid simulation pipeline (e.g., FDTD, BEM, or FEM) models acoustic scattering by the platform enclosure with physical accuracy that captures frequency-dependent diffraction and reflection patterns created by the enclosure geometry. The enclosure of a vehicle, drone, robot, or other platform creates frequency-dependent scattering patterns—including spectral notches, resonances, and directional shadowing—that vary with the direction of arrival of incoming sound relative to the enclosure geometry. By including wave-based-simulated enclosure scattering in the training data, the audio perception encoder 208 learns to interpret these scattering-induced spectral cues as directional information, supplementing and in some cases surpassing the spatial resolution achievable from inter-sensor time-of-arrival differences alone. This capability is particularly significant for platforms with a small number of sensors, including configurations with as few as a single sensor, where inter-sensor time-of-arrival cues are limited or absent but enclosure-scattering cues remain available.

The enclosure-scattering-based spatial cues are incorporated in both the pre-training and fine-tuning stages of the training curriculum as described in paragraph [0104]. During pre-training, the simulation pipeline exposes the audio perception encoder 208 to scattering patterns from a diverse set of virtual enclosure geometries. During fine-tuning, the pipeline computes wave-based impulse responses for the specific target platform enclosure geometry, enabling the system to achieve precise spatial localization on each deployment platform while maintaining cross-platform generality.

### Audio Question-Answer Dataset Generation

In some examples, the techniques herein relate to training the LLM 214 using an audio question-answer (AQA) dataset dedicated to spatial acoustic scenes. The AQA dataset comprises tuples of (audio data, question, answer), where the audio data is multi-channel sensor data (real or synthetic), the question is a natural language query about the acoustic scene, and the answer is a natural language response. Examples of AQA tuples include:
Audio: synthetic recording of an intersection with two vehicles, a pedestrian, and distant construction
Question: “How many distinct sound sources are present, and where are they located?”
Answer: “Four distinct sound sources are present. A vehicle engine at approximately 20 degrees azimuth, 12 meters distance, moving left to right. A second vehicle engine at approximately 340 degrees azimuth, 30 meters distance, stationary. A pedestrian footsteps at approximately 90 degrees azimuth, 4 meters distance, approaching. Construction hammering at approximately 180 degrees azimuth, approximately 150 meters distance.”
Audio: recording from a manufacturing facility with a CNC machine
Question: “Is the cutting tool operating normally?”
Answer: “The cutting tool is exhibiting increased broadband noise above 4 kHz compared to the baseline, suggesting early-stage tool wear. The spectral centroid has shifted upward by approximately 300 Hz. Recommend tool inspection.”
Audio: recording from a building HVAC system
Question: “What environmental conditions are affecting this audio?”
Answer: “The HVAC blower fan shows a 1.8× blade pass frequency harmonic that is 6 dB above normal levels, indicating possible blade imbalance or bearing wear. Background airflow noise is consistent with normal operation.”

The AQA dataset may be generated using the following approaches: (a) automatic generation from simulated scenes with programmatic ground truth (e.g., the simulation pipeline knows the positions, classes, and trajectories of all sources, and generates questions and answers from templates); (b) semi-automatic generation by applying existing models (e.g., speech-to-text engines, sound event detectors) to real recordings and generating questions and answers from the model outputs; (c) manual annotation by human annotators for high-value scenarios; and (d) Audio Instruction Generation (AIG), in which a language model (e.g., GPT or similar) is used to generate free-form, open-ended audio question-answer pairs from structured metadata about audio scenes. In the AIG approach, the structured metadata (including source classes, positions, trajectories, acoustic properties, and environmental conditions) is provided as input to a language model, which generates diverse natural language questions and corresponding answers that cover a wide range of query types (e.g., identification, localization, counting, comparison, temporal reasoning, causal reasoning). The AIG approach enables scalable generation of linguistically diverse AQA pairs without manual annotation effort, and ensures coverage of question types and phrasings that may not be captured by template-based generation.

### Zero-Shot and Few-Shot Capabilities

In some examples, the LLM 214, by virtue of its pre-trained language knowledge and the LoRA-adapted audio-language interface, can perform zero-shot classification of audio events that were not explicitly present in the training data. This capability arises because the LLM 214 has pre-trained knowledge about a wide range of sound-producing phenomena (e.g., the LLM knows what a “helicopter” sounds like from text descriptions, even if no helicopter recordings were present in the audio training data). When the audio perception encoder 208 produces embeddings for an unfamiliar sound that shares acoustic features with a known sound (e.g., the harmonic structure and modulation pattern of a helicopter are acoustically similar to the characteristics described in the LLM's pre-trained text knowledge), the LLM 214 can generate an appropriate classification or description.

In some examples, a text prompt may request the isolation of a specific sound source. The ALM head 216c may output descriptive information about the isolated source. In some examples, the ALM head 216c may transfer beyond the audio classes originally included in the training data, enabling zero-shot capability on previously unseen audio source classes. In some examples, a text prompt may request counting the number of specific sources, and the ALM head 216c may output the number of specified sources at different spatial locations.

### Edge Deployment

In some embodiments, the sensor data analysis system 200 is deployed on a computationally constrained edge device 1200. In some examples, the edge device 1200 may be an embedded computing module in an autonomous vehicle, a drone flight controller, a robot control unit, or an IoT gateway device. The edge device 1200 includes one or more processors 1202 (e.g., an ARM-based application processor, a GPU, a neural processing unit (NPU), an FPGA, or a combination thereof), memory 1204 (e.g., DRAM and flash storage), and one or more sensor interfaces 1206 for receiving data from the sensors.

The sensor data analysis system 200 is configured for edge deployment by use of the computational efficiency of the selective SSM-based audio perception encoder 208. Because the selective SSM processes the input sequence with linear complexity O(n) (as described in paragraph [0058]), the encoder can process multi-channel audio data in real time on edge devices with compute budgets comparable to those required for conventional single-channel speech-to-text engines.

In some examples, the multi-headed output architecture enables selective activation of output heads based on the compute budget and application requirements of the edge device. For a privacy-sensitive application (e.g., a building monitoring system), the time-sensitive classification head 216b and the anomaly detection head 216a may be activated while the ALM head 216c (which includes speech-to-text capability) is disabled, ensuring that speech content is never transcribed or stored. For a compute-constrained application (e.g., a low-power IoT sensor node), only the anomaly detection head 216a may be activated, providing a lightweight monitoring capability with minimal compute requirements.

In some examples, the entire sensor data analysis system 200, including the audio perception encoder 208, the dynamic-static interaction module 210, the projection layer 212, the LLM 214 with LoRA adapters, and all three output heads 216a-216c, is deployed on an edge device with a compute budget (in terms of multiply-accumulate operations per second and memory footprint) comparable to that of a conventional single-channel speech-to-text engine. This is achieved by the combination of: (a) the linear-complexity selective SSM encoder, which replaces the quadratic-complexity transformer encoder used in conventional approaches; (b) the multi-headed architecture, which shares the encoder computation across multiple tasks rather than requiring separate models; and (c) the LoRA-based LLM adaptation, which adds only a small number of additional parameters to the pre-trained LLM.

### Additional Sensor Modalities and Applications

Although many of the examples herein relate to audio data sensed by audio sensors (e.g., microphones, ambisonics microphones, etc.), the techniques herein may be applied to a variety of sensors and/or sensing devices. For example, the techniques may be applied to any one or more sensors that are configured to detect energy or waves in space (e.g., acoustic waves, electromagnetic waves, seismic waves).

For example, a vehicle may comprise vibration sensors, which may be prone to incorrect readings. A warning strip on the side of the road may trigger vibration data similar to that of an earthquake or collision. The techniques herein enable a model trained on both vibration and audio data to disambiguate such events by using cross-modal correlations (e.g., a warning strip produces a correlated acoustic signature that differs from an earthquake or collision).

In another example, touch and/or collision sensors may lack accurate time synchronization and sensitivity calibration. A collision sensor may not be sensitive enough to sense low-intensity or low-energy collisions (e.g., where a pedestrian bumps into a parked car, or a minor fender bender between vehicles) and/or may fail to differentiate between collisions and potholes accurately. The techniques herein enable the system to fuse collision sensor data with acoustic data and actuation signals to detect and classify low-intensity collisions with higher accuracy than any single sensor modality alone.

As another example, nearfield sensing is resource intensive, and in many instances, lidar arrays are employed to perceive a nearby environment. The techniques discussed herein reduce the costs (e.g., energy, monetary cost, time, engineering effort) associated with nearfield sensing. For example, applying the techniques herein with one or more ultrasonic sensors may be considerably less expensive than deploying a lidar sensor or array of lidar sensors for the same or similar tasks.

Additionally or alternatively, the techniques herein may be applied to underwater acoustic sensing environments. For example, the plurality of sensors may comprise hydrophones deployed on an underwater platform such as an autonomous underwater vehicle (AUV), a remotely operated vehicle (ROV), a surface vessel hull, a submarine, a towed array, or a seabed-mounted installation. In underwater deployments, the sensor geometry data 203 specifies the spatial positions of the hydrophones, and the dynamic-static interaction module 210 conditions the audio embeddings on the hydrophone array geometry in the same manner as for airborne sensor arrays. The propagation physics in underwater environments differ from atmospheric propagation: sound speed varies as a function of depth, temperature, salinity, and pressure, creating sound speed profiles that cause acoustic rays to refract (bend) along curved paths rather than straight lines. The hybrid simulation pipeline accounts for these underwater propagation effects by modeling depth-dependent sound speed profiles, bathymetry (seafloor geometry), sea surface conditions, and volume attenuation in the wave-based and ray-based simulation components. The data augmentation techniques are adapted for underwater conditions, including variation of sound speed profiles (e.g., thermocline depth and gradient), sea state (surface roughness affecting surface reflection loss), sediment type (affecting bottom reflection and absorption), and ambient noise characteristics (e.g., shipping noise, biological noise, wind-driven surface noise). The multi-headed output architecture applies to underwater applications including vessel classification and localization, marine mammal detection and species identification, underwater infrastructure monitoring, and diver or swimmer detection.

Additionally or alternatively, the techniques herein may be applied to any device, system, and/or sensor configured to detect or otherwise receive data in an environment. For example, the techniques herein may be applied to a microphone component of a smartphone or other mobile device, an ambisonics microphone, a custom-designed or otherwise unique sensor array of any one or more of the sensors discussed, and so on.

### Exemplary Method for Processing Multi-Channel Sensor Data

An exemplary method 800 for processing multi-channel sensor data through the sensor data analysis system 200 includes the following steps:

At step 802, the sensor data analysis system 200 receives multi-channel time-series sensor data from a plurality of sensors and receives sensor geometry data specifying the spatial positions of the sensors.

At step 804, the audio feature extractor 204 computes wavelet-based magnitude and phase features for each channel of the sensor data, producing a multi-channel feature tensor. In some examples, step 804 further includes computing mel-log spectrum features and concatenating them with the wavelet-based features. In some examples, step 804 further includes computing inter-channel phase difference features and concatenating them with the magnitude features.

At step 806, optionally, the neural array-to-ambisonics converter 206 converts the multi-channel feature tensor from the arbitrary array geometry to an ambisonics representation, using either an analytical or a data-driven conversion approach.

At step 808, the audio perception encoder 208, comprising a selective state space model, encodes the feature tensor into audio embeddings with linear computational complexity with respect to the input sequence length. The selective state space model processes the input sequence recurrently, maintaining a hidden state that is updated at each time step with input-dependent state transition parameters.

At step 810, the dynamic-static interaction module 210 fuses the audio embeddings (dynamic features) with the sensor geometry data (static features) using a cross-attention mechanism, producing geometry-conditioned audio embeddings. In some examples, step 810 further includes fusing actuation signal features with the audio embeddings.

At step 812, the multi-headed output module 216 processes the geometry-conditioned audio embeddings through one or more output heads: (a) the anomaly detection head 216a produces anomaly scores with spatial localization; (b) the time-sensitive classification head 216b produces classification probabilities with spatial localization for predefined event classes; and/or (c) the

ALM head 216c, in conjunction with the projection layer 212 and the LLM 214, produces natural language scene descriptions and/or speech transcriptions.

At step 814, the output from the LLM 214 is stored in the historical context buffer 222 for use as additional context in subsequent processing iterations.

### Exemplary Method for Generating Synthetic Training Data

An exemplary method 900 for generating synthetic multi-channel training data using the hybrid simulation pipeline is described below.

At step 902, the pipeline receives as input: (a) a geometric model of the platform on which sensors are mounted; (b) sensor positions on the platform; (c) acoustic properties of the platform surfaces; (d) a description of the deployment environment; and (e) positions, orientations, and source characteristics of one or more sound sources.

At step 904, the pipeline computes acoustic transfer functions from each source position to each sensor position using a wave-based simulation method (e.g., FDTD, BEM, or FEM) for the lower frequency range (below a crossover frequency). The wave-based simulation models wave phenomena including diffraction around the platform body and scattering from surface features.

At step 906, the pipeline computes acoustic transfer functions from each source position to each sensor position using a ray-based simulation method (e.g., GA, ISM, or beam tracing) for the higher frequency range (above the crossover frequency). The ray-based simulation models reflection, absorption, and propagation.

At step 908, the pipeline combines the wave-based and ray-based results in the frequency domain using a smooth crossover function, producing hybrid multi-channel impulse responses.

At step 910, the pipeline convolves clean, single-channel source audio signals with the hybrid impulse responses to produce synthetic multi-channel recordings.

At step 912, the pipeline applies data augmentation techniques including environmental noise superposition, atmospheric propagation effects, ground surface variation, sensor hardware modeling, and platform self-noise simulation.

At step 914, the pipeline generates ground truth labels (including source class, spatial position, trajectory, and distance) for each synthetic recording, producing labeled training data for the audio perception encoder 208 and the multi-headed output module 216.

### Automated Model Generation From Systems Engineering Specification

In some embodiments, the hybrid simulation pipeline and associated training procedures are orchestrated by an automated end-to-end system that receives a systems engineering specification file and produces a trained, platform-specific sensor data analysis model without manual intervention between the specification input and the model evaluation output. The systems engineering specification file comprises at least a geometric model of the target platform (e.g., a CAD model of a vehicle, drone, robot, building-mounted installation, surface vessel, or underwater vehicle), sensor positions on the target platform, deployment environment parameters (e.g., terrain type, expected noise floor, atmospheric conditions, expected sound source classes), and performance criteria (e.g., required detection range, classification accuracy, maximum false alarm rate, latency budget). From this specification, the automated system programmatically generates simulation configurations spanning a combinatorial space of source positions, trajectories, environmental conditions, and noise profiles. The automated system then executes the hybrid simulation pipeline described in paragraphs [0133] through [0138] to generate synthetic multi-channel training data, applies data augmentation and quality filtering (including filtering of corrupted samples, class balancing, and difficulty curriculum construction), fine-tunes a pre-trained foundation model on the augmented training data, and evaluates the resulting model against the performance criteria derived from the systems engineering specification file. The automated system outputs a deployable model artifact together with an evaluation report. This end-to-end automation enables rapid generation of platform-specific models for new deployment configurations without requiring manual data collection, manual annotation, or manual training pipeline configuration, thereby reducing the engineering effort required to adapt the sensor data analysis system to a new platform from months of specialized engineering to an automated process driven by the systems engineering specification.

### Hardware and Software Implementation

Any one or more of the techniques or processes herein may be executed by non-transitory computer-readable media storing processor-executable instructions. The processor-executable media, when executed by one or more processors, may cause the one or more processors to perform any of the methods, operations, or functions described herein.

As used herein, processor(s) may include one or more processors having multiple cores, including but not limited to central processing units (CPUs), graphics processing units (GPUs), digital signal processors, neural processing units (NPUs), tensor processing units (TPUs), microcontrollers, or other processing units known in the art. Alternatively or in addition, the functionality described herein can be performed, at least in part, by one or more hardware logic components including field-programmable gate arrays (FPGAs), application-specific integrated circuits (ASICs), or system-on-a-chip systems (SOCs). Each processor may possess its own local memory storing program components, program data, and/or one or more operating systems.

The embodiments described herein and illustrated in the accompanying drawings are non-limiting. Features described in connection with one embodiment may be combined with features of other embodiments. Modifications and variations apparent to those of ordinary skill in the art are intended to be included within the scope of the appended claims. The specific structural features and methodological acts described are merely illustrative of some embodiments that fall within the scope of the claims.

What is claimed is:

1. A computer-implemented method for analyzing multi-channel sensor data, the computer-implemented method comprising:
receiving, by one or more processors, multi-channel time-series sensor data from a plurality of sensors and sensor geometry data specifying spatial positions of the plurality of sensors;
encoding, by the one or more processors, the multi-channel time-series sensor data into audio embeddings using an audio perception encoder;
fusing, by the one or more processors, the audio embeddings with the sensor geometry data using a cross-attention mechanism in a dynamic-static interaction module to produce geometry-conditioned audio embeddings, wherein the audio embeddings serve as query inputs and the sensor geometry data serves as key and value inputs to the cross-attention mechanism, and wherein the audio embeddings represent time-variant features and the sensor geometry data represents time-invariant features; and
producing, by the one or more processors, at least one output from the geometry-conditioned audio embeddings using at least one output head.

2. The computer-implemented method of claim 1, further comprising:
computing, by the one or more processors, time-frequency feature representations from the multi-channel time-series sensor data prior to the encoding, wherein the time-frequency feature representations preserve both magnitude information and phase information;
wherein the audio perception encoder comprises a selective state space model having input-dependent state transition parameters, the selective state space model processing the time-frequency feature representations with computational complexity that is linear with respect to input sequence length;
wherein the at least one output comprises at least one of: an anomaly detection score with spatial localization, a classification of an acoustic event with spatial localization, or a natural language description of an acoustic scene; and
wherein the audio embeddings serve as query inputs and the sensor geometry data serves as key and value inputs to a cross-attention mechanism;
wherein the audio embeddings represent time-variant features and the sensor geometry data represents time-invariant features.

3. The computer-implemented method of claim 2, wherein fusing the audio embeddings with the sensor geometry data comprises:
projecting the audio embeddings into a query space using a first learned projection matrix to produce query vectors;
projecting the sensor geometry data into a key space and a value space using a second learned projection matrix and a third learned projection matrix to produce key vectors and value vectors, respectively; and
computing cross-attention between the query vectors and the key vectors and value vectors to produce the geometry-conditioned audio embeddings, wherein the cross-attention enables each audio embedding at each time frame to selectively attend to geometry features of different sensors in the plurality of sensors.

4. The computer-implemented method of claim 2, wherein computing time-frequency feature representations comprises:
applying a wavelet transform to each channel of the multi-channel time-series sensor data to produce complex-valued time-scale representations;
extracting magnitude components and phase components from the complex-valued time-scale representations; and
concatenating the magnitude components and the phase components along a channel dimension to produce a multi-channel feature tensor;
wherein the wavelet transform provides adaptive time-frequency resolution comprising higher temporal resolution at higher frequencies and higher frequency resolution at lower frequencies.

5. The computer-implemented method of claim 4, wherein the wavelet transform enables cross-frequency transfer learning, such that the audio perception encoder trained on sensor data in a first frequency range generalizes to sensor data in a second frequency range different from the first frequency range, without retraining the audio perception encoder for the second frequency range.

6. The computer-implemented method of claim 2, wherein producing at least one output comprises:
processing the geometry-conditioned audio embeddings through an anomaly detection head to produce anomaly detection scores with spatial localization at each time frame;
processing the geometry-conditioned audio embeddings through a time-sensitive classification head to produce classification probabilities for a set of predefined event classes, each classification comprising a class label, a confidence score, a spatial direction estimate, and a distance estimate, within a latency of less than 50 milliseconds from an event onset; and
processing the geometry-conditioned audio embeddings through a projection layer and a large language model to produce a natural language scene description including speech transcription, spatial localization of sound sources, and environmental characterization.

7. The computer-implemented method of claim 2, further comprising, before encoding the time-frequency feature representations:
converting the multi-channel time-series sensor data from an arbitrary sensor array geometry to a spherical harmonics representation using a machine-learned neural network model, wherein the machine-learned neural network model is trained on synthetic data generated by a simulation pipeline that models acoustic scattering by a platform on which the plurality of sensors are mounted, such that the machine-learned neural network model compensates for frequency-dependent and geometry-dependent scattering effects.

8. The computer-implemented method of claim 2, further comprising:
receiving actuation signals from a platform on which the plurality of sensors are mounted, the actuation signals comprising at least one of motor RPM signals, drive current signals, servo position signals, or wheel speed signals;
computing time-frequency representations of the actuation signals; and
concatenating the time-frequency representations of the actuation signals with the time-frequency feature representations of the multi-channel time-series sensor data before encoding by the audio perception encoder,
wherein the audio perception encoder jointly processes the multi-channel time-series sensor data and the actuation signals in a unified representation to distinguish self-generated noise from external acoustic events.

9. The computer-implemented method of claim 2, wherein producing the natural language description comprises:
mapping the geometry-conditioned audio embeddings to an input space of a pre-trained large language model via a learned projection layer;
concatenating the geometry-conditioned audio embeddings with text embeddings derived from a text instruction to result in concatenated embeddings;
processing the concatenated embeddings through the pre-trained large language model, wherein the pre-trained large language model is adapted through low-rank adapter matrices inserted into attention layers of the pre-trained large language model, and wherein during adaptation only the low-rank adapter matrices and the projection layer are trained while pre-trained parameters of the pre-trained large language model remain frozen; and
generating a natural language output from the pre-trained large language model.

10. The computer-implemented method of claim 1, wherein the sensor geometry data further comprises one or more of:
a surface geometry representation of a platform on which the plurality of sensors are mounted;
an atmospheric thermal gradient profile of a deployment environment;
a sound speed value or one or more variables contributing to sound speed including temperature, humidity, or molecular composition of a propagation medium; or
a terrain or ground surface parameter of the deployment environment.

11. The computer-implemented method of claim 1, wherein the multi-channel sensor data comprises acoustic data captured by a plurality of microphones mounted on an autonomous vehicle, and the at least one output comprises detection of an emergency vehicle siren and an estimated approach rate, direction, and distance of the emergency vehicle relative to the autonomous vehicle, wherein the distance estimate is derived at least in part from acoustic scattering properties of a surrounding built environment geometry provided in the sensor geometry data.

12. The computer-implemented method of claim 1, wherein the multi-channel sensor data comprises acoustic data captured by a plurality of sensors deployed on at least one of an unmanned aerial system, a terrestrial sensor array, or a combination thereof, the computer-implemented method further comprises suppressing self-noise of a platform using actuation signals indicative of at least rotor rotational speed, and the at least one output comprises detection and spatial localization of one or more aircraft in an airspace proximate to the plurality of sensors, including at least an estimated direction and distance of each detected aircraft.

13. The computer-implemented method of claim 1, wherein the plurality of sensors are mounted on or proximate to at least one of a vehicle, a robot, or a fixed infrastructure asset, and wherein the at least one output head comprises an anomaly detection head, the anomaly detection head producing an anomaly score indicating deviation from a learned baseline acoustic profile of the vehicle, the robot, or the infrastructure asset during normal operation, thereby enabling detection of mechanical degradation, component wear, or incipient failure conditions based on changes in acoustic emissions relative to the learned baseline.

14. The computer-implemented method of claim 13, wherein the plurality of sensors are mounted on a mobile robot that traverses a facility containing one or more monitored assets, the computer-implemented method further comprising suppressing self-noise of the mobile robot using actuation signals, and wherein the anomaly detection head produces spatially localized anomaly scores for the monitored assets during successive traversals of the facility.

15. A computer-implemented method for generating synthetic multi-channel training data for a sensor data analysis model, the computer-implemented method comprising:
receiving, by one or more processors, a geometric model of a platform, sensor positions on the platform, and a description of a deployment environment including one or more sound source positions;
computing, by the one or more processors, first acoustic transfer functions from each sound source position to each sensor position using a wave-based simulation method for a first frequency range below a crossover frequency;
computing, by the one or more processors, second acoustic transfer functions from each sound source position to each sensor position using a ray-based simulation method for a second frequency range above the crossover frequency;
combining, by the one or more processors, the first acoustic transfer functions and the second acoustic transfer functions in a frequency domain to produce hybrid multi-channel impulse responses;
convolving, by the one or more processors, single-channel source audio signals with the hybrid multi-channel impulse responses to produce synthetic multi-channel recordings; and
generating, by the one or more processors, ground truth labels for the synthetic multi-channel recordings, the ground truth labels comprising at least source class and spatial position for each sound source.

16. The computer-implemented method of claim 15, wherein the wave-based simulation method comprises at least one of a finite-difference time-domain (FDTD) simulation, a boundary element method (BEM) simulation, or a finite element method (FEM) simulation that models wave phenomena including diffraction around the platform and scattering from surface features of the platform, and wherein the ray-based simulation method comprises at least one of a geometrical acoustics (GA) simulation, an image source method (ISM) simulation, or a beam tracing simulation that models specular reflection, surface absorption, and long-distance propagation.

17. The computer-implemented method of claim 15, further comprising applying data augmentation to the synthetic multi-channel recordings, the data augmentation comprising at least one of:
superimposing recorded or synthesized ambient noise;
applying frequency-dependent atmospheric absorption to simulated propagation paths;
modeling ground surface acoustic properties for different surface types;
applying modeled sensor hardware transfer functions representing frequency response and self-noise characteristics of specific sensor hardware; or
generating and adding platform self-noise correlated with actuation signals.

18. The computer-implemented method of claim 15, further comprising:
generating audio question-answer tuples from the synthetic multi-channel recordings and the ground truth labels, each tuple comprising the synthetic multi-channel recording, a natural language question about an acoustic scene, and a natural language answer derived from the ground truth labels; and
training a large language model using the audio question-answer tuples.

19. The computer-implemented method of claim 15, wherein the geometric model of the platform comprises a three-dimensional surface mesh of a vehicle, drone, or robot body, and wherein the wave-based simulation method models frequency-dependent acoustic scattering by the platform, such that the hybrid multi-channel impulse responses capture scattering-induced spatial cues that are used by a sensor data analysis model for spatial localization.

20. The computer-implemented method of claim 15, further comprising:
applying modeled transfer functions to the synthetic multi-channel recordings to simulate recordings from different sensor hardware, wherein the modeled transfer functions represent at least one of frequency response, self-noise floor, sensitivity, harmonic distortion, or electrical interference characteristics of the different sensor hardware, such that a sensor data analysis model trained on the simulated recordings generalizes across different sensor hardware without retraining.

21. The computer-implemented method of claim 15, further comprising:
training the sensor data analysis model using synthetic multi-channel recordings generated across a plurality of distinct sensor array geometries, a plurality of distinct platform enclosure geometries, and a plurality of distinct deployment environments, wherein the plurality of distinct sensor array geometries includes variations in at least a number of sensors, a spatial arrangement of sensors, and an inter-element spacing of the sensors, and wherein the plurality of distinct platform enclosure geometries includes enclosures of vehicles, drones, robots, and building-mounted installations, such that the sensor data analysis model generalizes to sensor array geometries and platform enclosure geometries not present in the training data without retraining.

22. The computer-implemented method of claim 15, wherein the wave-based simulation method models frequency-dependent acoustic scattering by a platform enclosure geometry to produce scattering-induced spectral cues in the synthetic multi-channel recordings, the scattering-induced spectral cues comprising at least spectral notches, resonances, or directional shadowing that vary as a function of direction of arrival of sound relative to the platform enclosure geometry, and wherein a sensor data analysis model trained on the synthetic multi-channel recordings learns to exploit the scattering-induced spectral cues for spatial localization, enabling spatial localization of sound sources using a sensor array comprising as few as a single sensor mounted on a platform having an enclosure geometry that produces direction-dependent acoustic scattering patterns.

23. The computer-implemented method of claim 15, wherein the ground truth labels comprise exact spatial position coordinates, exact trajectory parameters, exact velocity values, and source class labels for each sound source, all derived directly from a programmatic specification of source positions and trajectories in a simulation pipeline rather than from manual annotation or auxiliary measurement systems,
wherein the single-channel source audio signals are convolved with multi-channel impulse responses computed across a combinatorial space of source positions, array geometries, platform enclosures, and environmental conditions to produce a training dataset that is at least one order of magnitude larger in total duration than the single-channel source audio signals.

24. The computer-implemented method of claim 15, wherein:
the geometric model, the sensor positions, and the description of the deployment environment are received as components of a systems engineering specification file that further comprises performance criteria;
the computer-implemented method further comprises automatically augmenting and curating the synthetic multi-channel recordings by applying data augmentation techniques and quality filtering; and
the computer-implemented method further comprises at least one of: (a) outputting the augmented and curated synthetic multi-channel recordings; or (b) automatically training a sensor data analysis model on the augmented synthetic multi-channel recordings by fine-tuning a pre-trained foundation model and automatically evaluating the trained sensor data analysis model against the performance criteria derived from the systems engineering specification file, wherein the computer-implemented method is performed without manual intervention.

25. The computer-implemented method of claim 15, wherein the ray-based simulation method models long-range atmospheric propagation by computing frequency-dependent atmospheric absorption in accordance with ISO 9613-1 (Acoustics—Attenuation of sound during propagation outdoors), such that the synthetic multi-channel training data captures distance-dependent spectral attenuation effects present in real-world outdoor acoustic environments.

26. A computer-implemented method for multi-task acoustic scene analysis, the computer-implemented method comprising:
receiving, by one or more processors, multi-channel sensor data from a sensor array;
processing, by the one or more processors, the multi-channel sensor data through a shared encoder backbone comprising a selective state space model or a transformer to produce shared audio embeddings;
producing, from the shared audio embeddings, outputs using at least two output heads selected from:
(a) a first output head that produces an anomaly detection score indicating deviation from a learned baseline acoustic profile,
(b) a second output head that produces a classification of an acoustic event selected from a hierarchical class label taxonomy, the classification comprising a class label, a confidence score, and a spatial localization estimate, and
(c) a third output head that, in conjunction with a large language model, produces a natural language description of an acoustic scene,
wherein the shared encoder backbone and the at least two output heads are co-deployed on a single computing device.

27. The computer-implemented method of claim 26, wherein the at least two output heads comprise all three of the first output head, the second output head, and the third output head, and wherein the third output head further performs automatic speech recognition of speech present in an acoustic scene.

28. The computer-implemented method of claim 26, wherein the shared encoder backbone performs feature extraction once to produce the shared audio embeddings, and the at least two output heads each operate on the shared audio embeddings, such that an aggregate computational cost of producing outputs from the at least two output heads is less than the computational cost of running independent models for each output head, enabling co-deployment of the at least two output heads on a computationally constrained edge device within a compute budget comparable to a single-task model.

29. A computer-implemented method for spatial localization of sound sources using a single sensor, the computer-implemented method comprising:
receiving, by one or more processors, time-series sensor data from a single sensor mounted on a platform having an enclosure geometry that produces direction-dependent acoustic scattering patterns;
processing, by the one or more processors, the time-series sensor data through an audio perception encoder to produce audio embeddings; and
estimating, by the one or more processors and from the audio embeddings, a direction of arrival of at least one sound source by exploiting scattering-induced spectral cues caused by the enclosure geometry of the platform, the scattering-induced spectral cues comprising at least spectral notches, resonances, or directional shadowing that vary as a function of direction of arrival of sound relative to the enclosure geometry,
wherein the audio perception encoder has been trained on data that includes acoustic scattering effects of platform enclosure geometries, enabling the audio perception encoder to interpret the scattering-induced spectral cues as directional information.
